(19) United States
(12) Patent Application Publication
(10) Pub. No.: US 2009/0202227 A1
(43) Pub. Date: Aug. 13, 2009

(54) METHOD AND APPARATUS FOR RECORDING DATA, METHOD AND APPARATUS FOR REPRODUCING DATA, AND RECORDING MEDIUM FOR RECORDING DATA

(75) Inventors: Yong-seok Jang, Hwaseong-si (KR); Jae-jun Lee, Suwon-si (KR); Kil-soo Jung, Osan-si (KR); Jae-seung Kim, Yongin-si (KR); Jae-phil Koo, Seoul (KR); Jung-wan Ko, Suwon-si (KR); Kwang-min Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/370,775

(22) Filed: Feb. 13, 2009

Related U.S. Application Data
(60) Provisional application No. 61/028,336, filed on Feb. 13, 2008.

(30) Foreign Application Priority Data
May 9, 2008 (KR) 10-2008-0043317

(51) Int. Cl. H04N 7/00; H04N 13/00; H04N 7/12; H04N 5/00

(52) U.S. Cl. 386/108; 348/43; 375/240.25; 386/126; 348/E13.001; 375/E07.027; 386/E05.064

(57) ABSTRACT

Provided are a method of reproducing a three-dimensional (3D) image using data stored in an optical recording medium. The method includes: reading 3D reproduction additional information from a recording medium to which at least one audio/video (AV) stream providing a plurality of related image signals and the 3D reproduction additional information for reproducing a 3D image using the plurality of related image signals are recorded; determining whether the plurality of related image signals are 3D image signals for reproducing a 3D image, based on the 3D reproduction additional information; and selectively reproducing a 3D image using the at least one AV stream and the 3D reproduction additional information based on a result of the determining.

### CROSS-REFERENCE TO RELATED PATENT APPLICATION

This application claims priority from U.S. Provisional Application No. 61/028,336, filed on Feb. 13, 2008, and Korean Patent Application No. 10-2008-0043317, filed on May 9, 2008 in the Korean Intellectual Property Office, the disclosures of which are incorporated herein in their entirety by reference.

### BACKGROUND OF THE INVENTION

1. Field of the Invention

The present invention relates to a method and apparatus for recording and reproducing data, and more particularly, to a method and apparatus for reproducing a three-dimensional (3D) image using an audio/video (AV) stream recorded in an optical recording medium, a method and apparatus for recording data so as to reproduce the 3D image, and a recording medium having recorded thereto data so as to reproduce the 3D image.

2. Description of the Related Art

There are limitations in related art storage mediums such as floppy disks and hard drives in terms of storage capacity and/or portability. Accordingly, optical recording mediums have been widely used to store high capacities of data and to satisfy needs for increased portability. Due to the increase in storage capability and reading speed of an optical recording medium, high quality video data and audio data can be stored and reproduced. In particular, according to a user's desires, a plurality of pieces of related image video data may be recorded together in one recording medium. As an example, in order to realize multi-angle viewing or picture-in-picture (PIP), a plurality of pieces of related image video data are recorded in one recording medium.

In order to support the multi-angle viewing, a plurality of image signals captured using a number of cameras are recorded in a recording medium. In the case of a football game, it is impossible for one camera to appropriately record all situations occurring on a football field. In actuality, a plurality of cameras are used to record the game and then images captured by a specific camera are provided. However, a user may not always be satisfied with the view that is currently provided, as in the case where the user desires to watch a favorite player, and the user may desire to watch the images captured by other cameras. As such, in order to satisfy the desires of a user, all video data captured by a plurality of cameras are recorded in an optical recording medium and the user selects the view that is desired to be watched so that desired images can be provided.

Moreover, in order to provide PIP, an image signal providing a main image and an image signal providing a sub-image are recorded together to a recording medium. A user sometimes desire to watch two or more images or to watch additional information related to the main image along with the main image. In this case, a plurality of the image signals recorded in the recording medium are used to simultaneously display the main image and the sub-image on one display device.

As described above, a plurality of pieces of related video data can be recorded to the related art optical recording medium and the plurality of pieces of related video data can be simultaneously reproduced in a PIP method or one of the plurality of pieces of related video data can be selected using a multi-angle method. However, the plurality of relating video data are used to reproduce two-dimensional (2D) image. A method of providing a 3D image using the plurality of pieces of related video data recorded to the optical recording medium is not yet provided.

### SUMMARY OF THE INVENTION

The present invention provides an optical recording medium having recorded thereto data so as to reproduce a 3D image, a method and apparatus for recording data in an optical recording medium so as to reproduce a 3D image, and a method and apparatus for reproducing a 3D image using an optical recording medium.

According to an aspect of the present invention, there is provided a method of recording data, the method including: receiving at least one AV stream which provides a plurality of related image signals; generating 3D reproduction additional information that is to be used when reproducing a 3D image using the plurality of related image signals; recording the at least one AV stream and the 3D reproduction additional information in a recording medium.

In generating 3D reproduction additional information, a plurality of pieces of 3D reproduction additional information which respectively corresponds to the plurality of related image signals may be generated, the 3D reproduction additional information each comprising at least one of reproduction mode information, multiplex format information, image depth information, and capturing information, the reproduction mode information representing whether the image signal corresponding to the 3D reproduction additional information is a 3D image signal for reproducing a 3D image, the multiplex format information representing multiplexing method of the image signal corresponding to the 3D reproduction additional information, the image depth information representing whether the image signal corresponding to the 3D reproduction additional information includes information relating to depth, and the capturing information representing parameter information used for capturing the image signal.

The capturing information may include at least one of relative position information, focal length, and an angle value, the relative position information representing the relative position of a camera capturing the image signal corresponding to the 3D reproduction additional information based on the position of a camera capturing a reference image signal, the focal length representing the focal length of a camera used in capturing the image signal corresponding to the 3D reproduction additional information, and the angle value representing the angle between a camera capturing the image signal corresponding to the 3D reproduction additional information and a reference point.

When the image signal corresponding to the 3D reproduction additional information comprises depth information, the 3D reproduction additional information may further include at least one of the maximum distance and the minimum distance between a camera capturing the image signal and the object to be captured.

Recording may include representing the plurality of related image signals as image signals for providing multi-angle or as image signals for providing picture in picture (PIP).

The recording medium may be a Blu-ray disc and the 3D reproduction additional information may be recorded in play item field for the image signal respectively corresponding to the 3D reproduction additional information.

The recording medium may be a digital versatile disc (DVD) and the 3D reproduction additional information is recorded in a C_field or a VTSI field for the image signal respectively corresponding to the 3D reproduction additional information.

According to another aspect of the present invention, there is provided a method of reproducing data, the method including: reading 3D reproduction additional information from a recording medium in which at least one AV stream providing a plurality of related image signals and the 3D reproduction additional information to be used when reproducing a 3D image using the plurality of related image signals are recorded; determining whether the plurality of related image signals are 3D image signals for reproducing a 3D image, based on the 3D reproduction additional information; and as the result of the determination, selectively reproducing a 3D image using the at least one AV stream and the 3D reproduction additional information.

The recording medium may have a plurality of pieces of 3D reproduction additional information respectively corresponding to the plurality of related image signals recorded thereto, the 3D reproduction additional information each comprising at least one of reproduction mode information, multiplex format information, image depth information, and capturing information, the reproduction mode information representing whether the image signal corresponding to the 3D reproduction additional information is a 3D image signal for reproducing a 3D image, the multiplex format information representing multiplexing method of the image signal corresponding to the 3D reproduction additional information, the image depth information representing whether the image signal corresponding to the 3D reproduction additional information includes information relating to depth, and the capturing information representing parameter information used for capturing the image signal.

Reproducing may include reading the at least one AV stream at a speed two times faster than it generally reads the AV stream, when it is determined that the plurality of related image signals are the 3D image signals.

Reproducing may include simultaneously decoding the at least one AV stream using a plurality of decoders, when it is determined that the plurality of related image signals are the 3D image signals.

Reproducing may include: decoding at least one AV stream; and outputting information about a reference image signal from among the plurality of related image signals and the at least one decoded AV stream to a display device.

According to another aspect of the present invention, there is provided an apparatus for recording data, the apparatus including: a receiver receiving at least one AV stream which provides a plurality of related image signals; an information generator generating 3D reproduction additional information that is to be used when reproducing a 3D image using the plurality of related image signals; and a recorder recording the at least one AV stream and the 3D reproduction additional information in a recording medium.

According to another aspect of the present invention, there is provided apparatus for reproducing data, the apparatus including: a reading unit reading 3D reproduction additional information from a recording medium in which at least one AV stream providing a plurality of related image signals and the 3D reproduction additional information to be used when reproducing a 3D image using the plurality of related image signals are recorded; a determining unit determining whether the plurality of related image signals are 3D image signals for reproducing a 3D image, based on the 3D reproduction additional information; and a reproducing unit selectively reproducing a 3D image using the at least one AV stream and the 3D reproduction additional information, as the result of the determination.

According to another aspect of the present invention, there is provided an optical recording medium in which at least one AV stream which provides a plurality of image signals are recorded further has 3D reproduction additional information that is to be used when reproducing a 3D image using the plurality of image signals recorded thereto.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a recording device according to an exemplary embodiment of the present invention;

FIG. 2A illustrates a data structure of a Blu-ray disc for multi-angle reproduction according to an exemplary embodiment of the present invention;

FIG. 2B illustrates a data structure of a Blu-ray disc for picture in picture (PIP) reproduction according to an exemplary embodiment of the present invention;

FIG. 3A illustrates a data structure of a DVD for reproducing a 3D image according to an exemplary embodiment of the present invention;

FIG. 3B illustrates an exemplary title formed of a plurality of program chains (PGCs);

FIG. 3C illustrates an exemplary data structure of PGC;

FIG. 3D illustrates forming a path block with a plurality of cells which is the minimum unit for reproducing;

FIG. 4 is a block diagram of an apparatus for reproducing a recording medium according to an exemplary embodiment of the present invention;

FIG. 5 is a flowchart illustrating a method of reproducing a 3D image by reading the Blu-ray disc of FIG. 2 according to an exemplary embodiment of the present invention;

FIG. 6A is a block diagram of an apparatus for reproducing a recording medium according to another exemplary embodiment of the present invention;

FIG. 6B is a block diagram of the apparatus for reproducing a recording medium of FIG. 6A according to another exemplary embodiment of the present invention;

FIG. 7 is a flowchart illustrating a method of recording data according to an exemplary embodiment of the present invention; and

FIG. 8 is a flowchart illustrating a method of reproducing data recorded to a recording medium according to an exemplary embodiment of the present invention.

### DETAILED DESCRIPTION OF EXEMPLARY EMBODIMENTS OF THE INVENTION

Hereinafter, exemplary embodiments of the present invention will be described more fully with reference to the accompanying drawings.

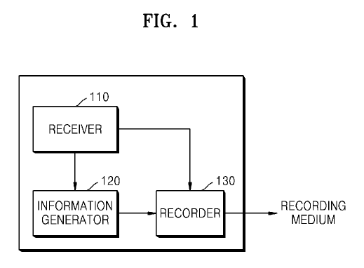

FIG. 1 is a block diagram of a recording device 100 according to an exemplary embodiment of the present invention.

The recording device 100 includes a receiver 110, an information generator 120 and a recorder 130.

The receiver 110 receives at least one AV stream which provides a plurality of related image signals. The plurality of related image signals may be multiplexed and exist in one AV stream or only one image signal may exist in one AV stream.

In addition, the plurality of related image signals may be 2D image signals for multi-angle reproduction or PIP reproduction or may be 3D image signals for 3D image reproduction.

The information generator 120 generates 3D reproduction additional information. In this specification, the 3D reproduction additional information denotes information used when a 3D image is reproduced using the plurality of related image signals recorded in a recording medium. The information generator 120 may generate single 3D reproduction additional information which can be applied to all related image signals and may also generate a plurality of pieces of 3D reproduction additional information which corresponds to each of the related image signals. Hereinafter, it is assumed that the information generator 120 generates a plurality of pieces of 3D reproduction additional information which respectively corresponds to the plurality of related image signals.

The 3D reproduction additional information may include at least one of reproduction mode information, multiplex format information, image depth information, and capturing information.

The reproduction mode information represents whether the image signal corresponding to the 3D reproduction additional information is a 3D image signal for reproducing a 3D image. As in Table 1 below, when the value of the reproduction mode information is ‘0,’ the plurality of related image signals stored in a recording medium are a 2D image and when the value of the reproduction mode information is ‘1,’ the plurality of related image signals stored in a recording medium are a 3D image.

TABLE 1
Reproduction Mode Information

| Value | Description |
|---|---|
| 0 | 2D image |
| 1 | 3D image |

The multiplex format information represents multiplexing method of an image signal which corresponds to the 3D reproduction additional information. The plurality of related image signals may be multiplexed and exist in at least one AV stream. As such, the multiplex format information is used by an apparatus for reproducing in separating the image signals when the plurality of related image signals are multiplexed into one AV stream. However, even if the image signals are not multiplexed, the multiplex format information may be included in the 3D reproduction additional information so as for an apparatus for reproducing to refer to the information when the apparatus for reproducing reproduces the image signals.

As in Table 2 below, when the value of the multiplex format information is ‘00’, the image signals are multiplexed using a ‘side by side’ method. In the case of one frame that is multiplexed into reproduce a stereo image, the frame may be multiplexed by being divided into two including information relating to a left view image in the left side of the divided frame and including information relating to a right view image in the right side of the divided frame. When the value of the multiplex format information is ‘01’, the image signals are multiplexed using a ‘top and bottom’ method. In this case, the frame may be multiplexed by being divided into two including information relating to a left view image in the top and including information relating to a right view image in bottom.

When the value of the multiplex format information is ‘10,’ the image signals are multiplexed using a ‘frame sequential’ method. In this case, the frame including information relating to the left view image and the frame including information relating to the right view image may be multiplexed so as to be alternately displayed. For example, an even frame may include the right view image and an odd frame may include the left view image.

When the value of the multiplex format information is ‘11’, the image signals are multiplexed using a ‘field sequential’ method. In this case, odd-number fields in the frame include information relating to the left view image and even-number fields in the frame include information relating to the right view image.

TABLE 2
Multiplex Format Information

| Value | Description |
|---|---|
| 00 | side by side method |
| 01 | top and bottom method |
| 10 | frame sequential method |
| 11 | field sequential method |

The image depth information represents whether the image signal corresponding to the 3D reproduction additional information includes information relating to depth. A right view image signal and a left view image signal may be recorded together in a recording medium. However, according to exemplary embodiments, one of the right view (or left view) image signals may be recorded in a recording medium and a depth image for the recorded image can be additionally recorded in a recording medium.

As such, the image including depth information for a reference image denotes the depth image in this specification.

As in Table 3 below, when the value of the image depth information is ‘0,’ depth information does not exist in the image signal. In other words, the image signal corresponding to the 3D reproduction additional information is not the depth image. When the value of the image depth information is ‘1,’ depth information exists in the image signal. In other words, the image signal corresponding to the 3D reproduction additional information is the depth image.

TABLE 3
image depth information

| Value | Description |
|---|---|
| 0 | No depth image |
| 1 | Depth image |

The capturing information represents information about the capturing the image signal, the image signal corresponding to the 3D reproduction additional information and may be designated as a camera parameter. The capturing information may include relative position information, focal length, and an angle value.

Referring to Table 4 below, the capturing information includes relative position information, focal length, and an angle value.

The relative position information represents the position of a camera in use for capturing the image signal corresponding to the 3D reproduction additional information. The relative position information represents the position of the camera used in capturing of the image signal corresponding to the 3D reproduction additional information using an absolute coordinate or using a relative position from the position of a reference camera.

In this specification, the relative position information is represented by a ‘translation’ variable and represents the relative position of the camera used in capturing the image signal corresponding to the 3D reproduction additional information based on the position of the camera used in capturing a reference image. In the case of a stereo image, the distance from the camera which captured the reference image can be represented and in the case of a multi-view, the relative position can be represented using three coordinate values of x, y, and z.

The focal length is represented by a ‘focallength’ variable and represents the focal length of the camera used in capturing the image signal corresponding to the 3D reproduction additional information. The angle value is represented by a ‘rotation’ variable and represents the angle to some extent that the camera used in capturing the image signal corresponding to the 3D reproduction additional information is rotated from a reference point. The angle value may be represented using the relative angle with a reference camera or may represent information about the camera being rotated based on a reference coordinate system after setting the reference coordinate system.

TABLE 4
Capturing Information

| Value | Description |
|---|---|
| translation[3] | Relative position from a reference camera |
| focallength | Focal length of a camera |
| rotation[3] | Angle of a camera based on an absolute coordinate |

A capturing information index representing whether the capturing information exists in the 3D reproduction additional information may be further included in the 3D reproduction additional information. Referring to Table 5 below, when the value of the capturing information index is ‘0,’ the capturing information does not exist in the 3D reproduction additional information and when the value of the capturing information index is ‘1,’ the capturing information exists in the 3D reproduction additional information.

TABLE 5
Capturing Information Index

| Value | Description |
|---|---|
| 0 | Capturing information does not exist |
| | (No camera parameter information) |
| 1 | Capturing information exists |
| | (existence of camera parameter information) |

The distance information between the camera used in capturing the image signal corresponding to the 3D reproduction additional information and the object to be captured may be further included in the 3D reproduction additional information. The distance information between the camera and the object to be captured exists only when the image depth information is ‘1’ and includes the maximum and minimum distance between the camera and the object to be captured.

Referring to Table 6 below, the maximum distance between the camera and the object to be captured is represented by a ‘max depth’ variable and the minimum distance between the camera and the object to be captured is represented by a ‘min depth’ variable.

The distance information between the camera and the object to be captured may be used when a 3D image is reproduced and may be used as a parameter referred to in controlling of a reproduction environment, for example, in controlling the depth of the 3D image signals.

TABLE 6
Distance Information Between the Camera
and the Object to be Captured

| Value | Description |
|---|---|
| max_depth | Distance between the camera and the furthest object to be |
| | captured |
| min_depth | Distance between the camera and the nearest object to be |
| | captured |

The recorder 130 records at least one AV stream and the 3D reproduction additional information in an optical recording medium. Examples of the optical recording medium may include a Blu-ray disc and DVD.

When a Blu-ray disc is used, the 3D reproduction additional information may be recorded in a field called ‘play item’. In other words, the 3D reproduction additional information is included in and recorded in the play item for the image signals corresponding to the 3D reproduction additional information. When DVD is used, the 3D reproduction additional information may be recorded in a C_CAT field or a VTSI field. In other words, the 3D reproduction additional information is included in and recorded in the VTSI field or the C_CAT field for the image signal corresponding to the 3D reproduction additional information.

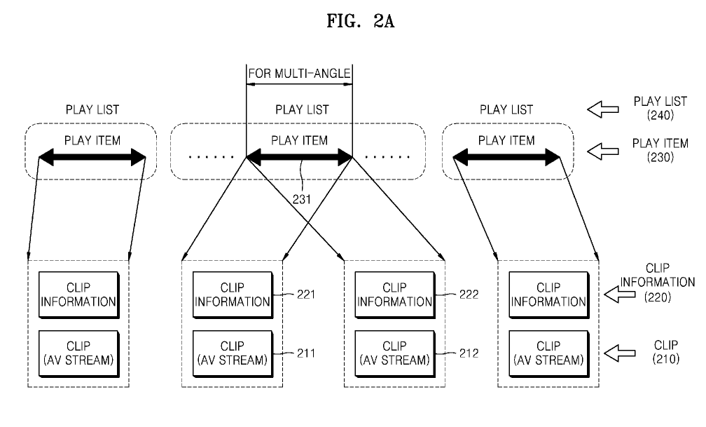

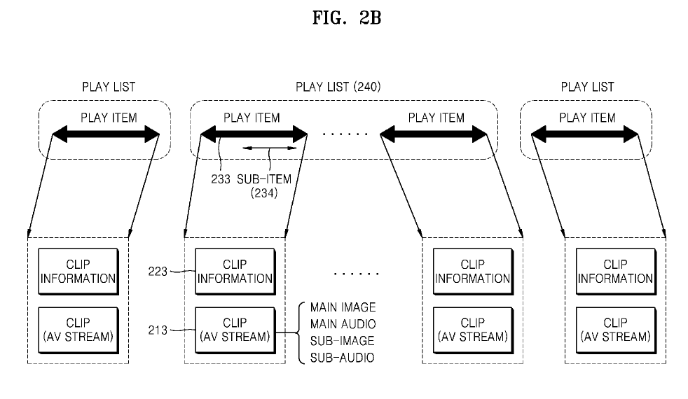

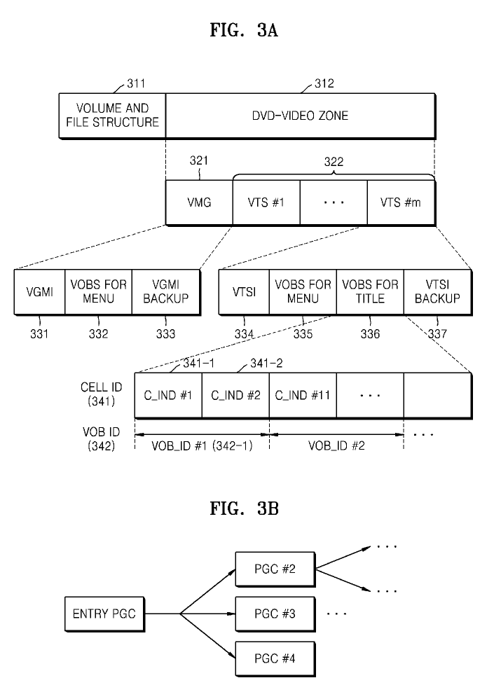

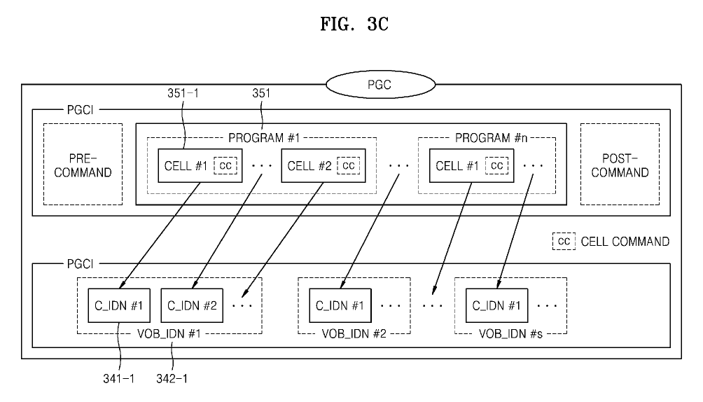

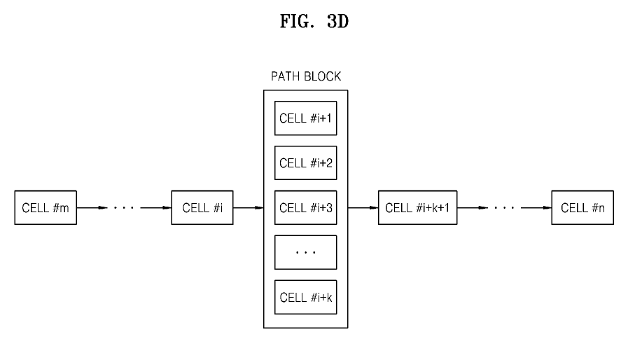

While the recorder 130 records at least one AV stream providing a plurality of image signals to the recording medium, the plurality of image signals may be represented as the image signals for providing multi-angle or the image signals for providing PIP. Thus, a 3D image can be reproduced without changing a data structure used in a conventional optical recording medium. The data structure of a Blu-ray disc and DVD and recording and reproducing the 3D image signals will be described in more detail with reference to FIGS. 2 and 3.

FIG. 2A illustrates a data structure of a Blu-ray disc for multi-angle reproduction according to an exemplary embodiment of the present invention.

A schematic data structure of a Blu-ray disc includes a clip 210, clip information 220, a play item 230, and a play list 240. The clip 210 is an AV stream that is compressed and encoded to reproduce audio data and video data. The AV stream providing one content may be formed of a plurality of clips or may correspond to one clip.

The clip information 220 includes information relating to the corresponding clip. As an example, the clip information 220 may include encoding attribute information such as resolution, size, and format information of the corresponding clip and a physical position of the optical recording medium in which the corresponding clip is recorded.

The play item 230 includes time information based on the reproduction time that is the time in difference between the start time In-time and the end time Out-time of the corresponding clip. More specifically, the reproduction start time and the reproduction end time in the clip are determined. Thus, when the play item 230 and the clip information 220 are used, the position to start reproducing and the position to end reproducing can be known.

The play list 240 is formed of one or more play item 230 and is a fundamental unit for reproduction. The apparatus for reproducing (not shown) sequentially reproduces AV contents using the play item 230 included in the play list 240.

Referring to FIG. 2A, clips 211 and 212 and clip information 221 and 222 are recorded in the optical recording medium for multi-angle reproduction. In addition, information relating to multi-angle (hereinafter referred to as “multi-angle information”) is further included in a play item 231. The multi-angle information includes multi-angle existence information, the number of clips for multi-angle reproduction, and additional information about the clips for multi-angle reproduction. An apparatus for reproducing (not shown) searches for and reproduces the clips 211 and 212 for multi-angle reproduction using the play item 231 and the clip information 221 and 222.

The plurality of related image signals for reproducing a 3D image may be represented as the image signals for providing multi-angle reproduction and may be recorded. That is, the clips 211 and 212 represented as an image for multi-angle may be the 3D image signals. Here, simultaneously, multi-angle information is recorded in the play item and the 3D reproduction additional information corresponding to the clips 211 and 212 is recorded in the play item 231. The apparatus for reproducing which will be described later reproduces a 3D image using the multi-angle information and the 3D reproduction additional information included in the play item 231.

FIG. 2B illustrates a data structure of a Blu-ray disc for PIP reproduction according to an exemplary embodiment of the present invention. Hereinafter, the PIP reproduction will be described with reference to a clip 213.

A plurality of image signals are needed for PIP reproduction and the image signals may be multiplexed into one AV stream or may exist in a plurality of AV streams without being multiplexed. In FIG. 2B, it is assumed that a main image signal and a sub-image signal which are needed for PIP reproduction are multiplexed and are included in the clip 213.

A play item 233 and a sub-play item 234 are included in the play list 240 for PIP reproduction. The sub-play item 234 is connected to the clip 213 and clip information 223 for the sub-image and includes reproduction time information based on a reproduction interval between the reproduction start time and the reproduction end time of the sub-image. In addition, the sub-play item 234 includes information about whether the sub-image is multiplexed into the main image or exists separately from the main image without being multiplexed.

The plurality of related image signals for reproducing a 3D image may be represented as the image signals for providing PIP and recorded. In other words, the clip 213 for PIP are the 3D image signals. Here, simultaneously, PIP information is recorded in the play item 233 and the 3D reproduction additional information corresponding to the clip 213 for providing PIP is recorded in the play item 233. That is, a list of elementary stream (ES) providing a 3D image is defined in the play item 233. The apparatus for reproducing which will be described later reproduces a 3D image using the PIP information and the 3D reproduction additional information included in the play item 233.

FIG. 3A illustrates a data structure of a DVD for reproducing a 3D image according to an exemplary embodiment of the present invention.

Referring to FIG. 3A, in DVD, a video storage region 312 is divided into a VMG region 321 and a plurality of VTS regions 322. The VMG region 321 includes header information about the whole video title and the VTS regions 322 include a title. In general, the VMG region 321 is formed of 2or 3 files and each of the VTS regions 322 is formed of 3 to 12 files.

The VMG region 321 includes a VMGI region 331, a VOBS region 332, and a VMGI backup region 333, wherein the VMGI region 331 provides additional information about the VMG region 321 and the VOBS region 332 includes video object information relating to a menu. Each of the regions exists as one file. However, the VOBS region 332 may not exist depending on the particular exemplary embodiment employed.

The VTS regions 322 includes video title set information (VTSI) 334, a VOBS 335, a VOBS 336, and a VTSI backup region 337, wherein VTSI 334 represents information about video title set, the VOBS 335 includes presentation data for a menu, the VOBS 336 which is information about a video object of a title, and the VTSI backup region 337 in which VTSI backup data is recorded.

Here, the VOBS 335 including presentation data for a menu may not always exist and thus may not exist depending on the particular exemplary embodiment employed.

Each of the VOBS 336 is classified again into VOBs and cells that are units for recording and one VOB is formed of a plurality of cells. Thus, the minimum unit for recording is a cell. In FIG. 3A, a VOB ID #1 342-1 is formed of two cells 341-1 and 341-2.

FIG. 3B illustrates a title formed of a plurality of program chains (PGCs).

Referring to FIG. 3B, data is reproduced through a PGC #2 and the next data is reproduced by selecting one of a plurality of PGCs. A control signal representing which one of the plurality of PGCs is selected is recorded within DVD. As such, controlling of the reproduction order of data denotes navigation and the control signal determining the reproduction order may be recorded in PGC information (PGCI).

FIG. 3C illustrates a data structure of the PGC. The PGC is stored in a form of PGCI. The PGCI is formed of pre-command, post-command, and a plurality of pieces of program information, wherein the pre-command and post-command include a navigation control signal. The pre-command is executed before reproducing data using the corresponding PGC and the post-command is executed after reproducing data using the corresponding PGC. Each of the program is formed of a plurality of pieces of cell information. The cell information within the program is a unit for reproducing. This cell information is the minimum unit for recording in VOB described above with reference to FIG. 3B and is connected to the cell one by one. In FIG. 3, a cell #1 351-1 in a program #1 351 is connected to the first cell 341-1 in the VOB ID #1 342-1. The cell as a unit for reproducing includes a cell command executed when reproducing of data corresponding to the cell is completed.

Accordingly, PGCI hierarchically describes a unit for reproducing, PGC, and connects the cell, the minimum unit for reproducing, to the cell, the minimum unit for recording. A PGC is formed of connection between the plurality of cells, the minimum unit for reproducing. In particular, the plurality of cells is sometimes formed as a path block

FIG. 3D illustrates forming a path block with a plurality of cells which is the minimum unit for reproducing. The plurality of cells is arranged in parallel in PGC and a part set to reproduce one cell from among the cells arranged in parallel denotes the path block. The cells forming the path block may have the same reproduction time, however, may each have different reproduction times.

This path block may be used when multi-angle is to be reproduced. Here, when multi-angle is to be reproduced, the cell, the minimum unit for reproducing, forming the path block has the same reproduction time and the cells included in the path block respectively correspond to angles.

In addition, PGCI includes a reproduction information table and C_CAT data, wherein the reproduction information table prescribes the reproduction order of the cell, the minimum unit for reproducing and C_CAT data represents the attribute of the cell, the minimum unit for reproducing. A data structure of C_CAT is as follows.

TABLE 7

| | bit | | | | | | | | | | | |
|---|---|---|---|---|---|---|---|---|---|---|---|---|
| | 0-7 | 8-15 | 16-20 | 21 | 22 | 23 | 24 | 25 | 26 | 27 | 28, 29 | 31, 31 |
| Descrip- | Cell | Cell | Cell | Access | Cell | Reserved | Seamless | STC | Interleaved | Seamless | Cell | Cell |
| tion | Command | Still | type | Restriction | Repro- | | Angle | Discontinuous | Arrangement | Reproduction | Block | Block |
| | Number | Time | | Flag | duction | | Change | Flag | Flag | Flag | Type | Mode |
| | | | | | Mode | | Flag | | | | | |

A part of the 3D reproduction additional information according to the present invention may be recorded in a reserved field having the C_CAT data structure described in Table 7. As an example, a ‘Cell Block Type’ field (at the 28^{th}˜29^{th} bit) represents the type of the cell. When the cell, the minimum unit for reproducing, represents data for reproducing multi-angle in the ‘Cell Block Type’ field, the reproduction mode information may be included in the reserved region. When the corresponding data is to reproduce a 3D image, the number and the view of the multi-angle are recognized as the number and the view of the image signals used in reproducing a 3D image.

Also, remaining information included in the 3D reproduction additional information may be additionally included in the C_CAT field to be provided, may be provided in a file form separately from the C_CAT field, or may be provided by being included in the VTSI region.

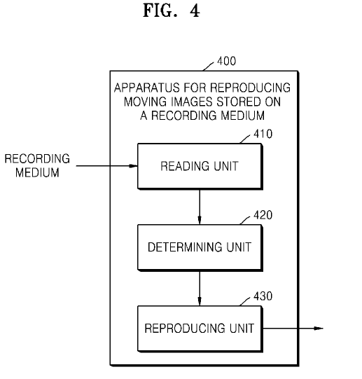

FIG. 4 is a block diagram of an apparatus for reproducing a recording medium 400 according to an exemplary embodiment of the present invention.

The apparatus for reproducing a recording medium 400 includes a reading unit 410, a determining unit 420, and a reproducing unit 430.

The reading unit 410 reads the 3D reproduction additional information and at least one AV stream from an optical recording medium in which the at least one AV stream and the 3D reproduction additional information providing a plurality of related image signals are recorded. The 3D reproduction additional information is used when a 3D image is reproduced using the plurality of related image signals. The plurality of related image signals may be represented as the image signals for providing multi-angle to be recorded or may be represented as the image signals for providing PIP to be recorded.

Only one 3D reproduction additional information to be applied to the plurality of image signals may be recorded in a recording medium. However, a plurality of pieces of 3D reproduction additional information which correspond to each of the plurality of related image signals may be recorded in the recording medium. Hereinafter, for convenience of description, it is assumed that the plurality of pieces of 3D reproduction additional information which correspond to each of the plurality of related image signals are recorded in the recording medium. In other words, the image signals which correspond to each of the 3D reproduction additional information are controlled and a 3D image is reproduced.

Examples of the recording medium may include the optical recording medium such as a Blu-ray disc and DVD.

When a Blu-ray disc is used, the 3D reproduction additional information may be recorded in a play item for the image signals corresponding to the 3D reproduction additional information. When DVD is used, the 3D reproduction additional information may be recorded in the C_CAT field or the VTSI field for the image signal corresponding to the 3D reproduction additional information.

The determining unit 420 determines whether the plurality of related image signals are used to reproduce a 3D image based on the 3D reproduction additional information.

Each of the 3D reproduction additional information may include reproduction mode information representing whether the corresponding image signals are to reproduce a 3D image.

According to the result of determination by the determining unit 420, the reproducing unit 430 selectively reproduces a 3D image using at least one AV stream and the 3D reproduction additional information. That is, when it is determined that the plurality of related image signals are not to reproduce a 3D image, the reproducing unit 430 reproduces a 2D image using at least one AV stream. Here, the 3D reproduction additional information may not be used. On the other hand, when it is determined that the plurality of related image signals are to reproduce a 3D image, the reproducing unit 430 reproduces a 3D image.

Hereinafter, it is assumed that the plurality of related image signals are determined to reproduce a 3D image.

The 3D reproduction additional information may include multiplex format information representing multiplexing of the image signal which corresponds to the 3D reproduction additional information. In this case, the reproducing unit 430 demultiplexes the at least one AV stream using the multiplex format information, thereby obtaining the plurality of related image signals.

The 3D reproduction additional information may include image depth information representing whether an image signal corresponding to the 3D reproduction additional information includes information relating to depth. The image signal including depth information is an image designated as a depth image and is information for reproducing a reference image to a 3D image. When the image signal corresponding to the 3D reproduction additional information is the depth image, the reproducing unit 430 processes the depth image and obtains information needed to reproduce the reference image to a 3D image. As an example, the reference image is the left view image. When the image signal corresponding to the 3D reproduction additional information is the depth image, the reproducing unit 430 restores the right view image using the depth image and reproduces a stereo image using the right view image and the left view image.

In addition, the 3D reproduction additional information including the image depth information may further include one of the maximum distance and the minimum distance between the camera capturing the image signal and the object to be captured. The maximum distance and the minimum distance may be used when a user controls a reproduction environment or when the reproducing unit 430 reproduces a 3D image.

The 3D reproduction additional information may include capturing information of the corresponding image signal. As described above, the capturing information may include at least one of relative position information of the camera used in capturing the corresponding image signal, focal length, and the angle value. The reproducing unit 430 can reproduce a high quality 3D image using the capturing information.

When it is determined that the plurality of related image signals reproduce a 3D image, two or more image signals may be displayed within a predetermined time. Accordingly, the reproducing unit 430 may include a plurality of decoders so as for AV streams to be simultaneously decoded in each decoder. As an example, when it is assumed that the left view image signal and the right view image signal are provided through two AV streams, one decoder decodes the AV stream which provides the left view image signal, while other decoder decodes the AV stream which provides the right view image signal.

Here, when a 2D image is reproduced, the reading unit 410 reads the AV stream at a speed two times faster than it generally reads the AV stream, thereby transmitting the read AV stream to the decoder or the reading unit 410 may load the AV stream in advance before reproducing and may only read the AV stream that is not loaded when reproducing.

Meanwhile, in order to smoothly reproduce a 3D image in a display device, the reproducing unit 430 may transmit decoded image signals along with information relating to a reference image signal to a display unit. As an example, In the case of multi-angle, the reproducing unit 430 transmits information relating to the image signal with angle ‘0.’ For example, the reproducing unit 430 may insert information about whether the transmitted image is a reference image. In the case of PIP, the reproducing unit 430 transmits information relating to the main image signal.

The reproducing unit 430 may include an outputting unit (not shown) outputting information about a reference image signal from among the plurality of related image signals and the at least one decoded AV stream to a display device.

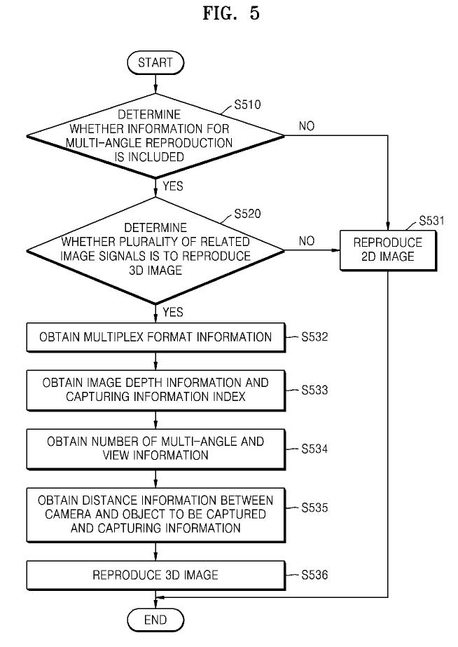

FIG. 5 is a flowchart illustrating a method of reproducing a 3D image by reading the Blu-ray disc of FIG. 2 according to an exemplary embodiment of the present invention.

In operation S510, it is determined whether the play item includes information for multi-angle reproduction. If it is determined that the information for multi-angle reproduction is not included, a 2D image is reproduced in operation S531.

If it is determined that the information for multi-angle reproduction is included, the 3D reproduction additional information recorded to the Blu-ray disc is read and it is determined whether the plurality of related image signals represented as for the multi-angle reproduction are to reproduce a 3D image in operation S520. More specifically, it is determined using the reproduction mode information included in the 3D reproduction additional information. When the plurality of related image signals are to reproduce a 3D image, operation S532 is executed; otherwise, operation S531 is executed.

In operation S532, the multiplex format information is obtained. When two or more image signals are multiplexed into one AV stream, demultiplexing is performed using the multiplex format information.

In operation S533, the image depth information and the capturing information index are obtained. The image depth information represents whether the depth image exists in the plurality of related image signals include and the capturing information index represents whether the capturing information is included in the 3D reproduction additional information.

In operation S534, the number of multi-angles and the view information are obtained. The plurality of related image signals for reproducing a 3D image may be represented as the image signals for providing multi-angle and recorded. In this case, the number of multi-angles corresponds to the number of the image signals used in reproducing a 3D image and the view information corresponds to the view information of the image signals used in reproducing a 3D image.

In operation S535, at least one of distance information between the camera capturing the image signal and the object to be captured and the capturing information are obtained. When the depth image exists, information about the maximum distance and the minimum distance between the camera capturing the image signal and the object to be captured is included in the 3D reproduction additional information. In addition, in operation S533, when the capturing information index represents that the capturing information exists, the capturing information is included in the 3D reproduction additional information.

In operation S536, a 3D image is reproduced using the 3D reproduction additional information and the at least one AV stream recorded in the recoding medium.

Even when the plurality of related image signals to be used in reproducing a 3D image are represented as the image signals for providing PIP, a 3D image can be reproduced using the method described above. However, a difference is that PIP defines the list of the image signals providing the main image and sub-image in the play item. In this case, in operation S534, the number of the image signals providing the main image and the sub-image is recognized as the number of the image signals to be used in reproducing a 3D image and the view information of the image signals is obtained using the information about the main image and the sub image.

In FIG. 5, the method of reproducing a 3D image using the AV stream recorded in the Blu-ray disc is described. However, a 3D image can be reproduced using AV streams recorded in a DVD. In this case, the 3D reproduction additional information is recorded in the C_CAT field or the VTSI field so that in operation S520, the 3D reproduction additional information is obtained through C_CAT or VTSI.

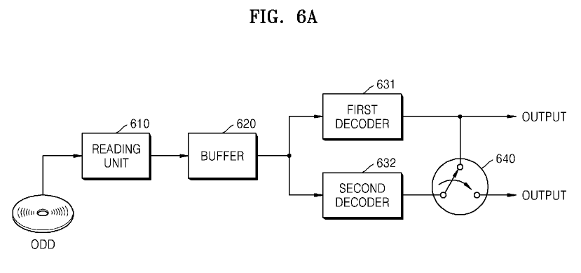

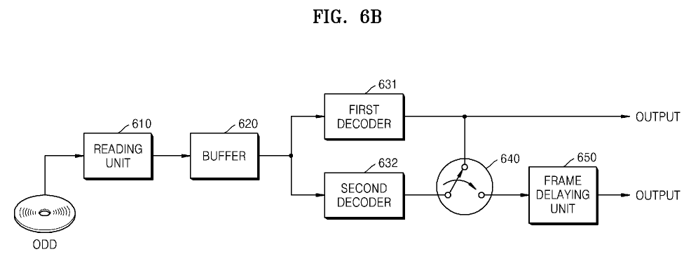

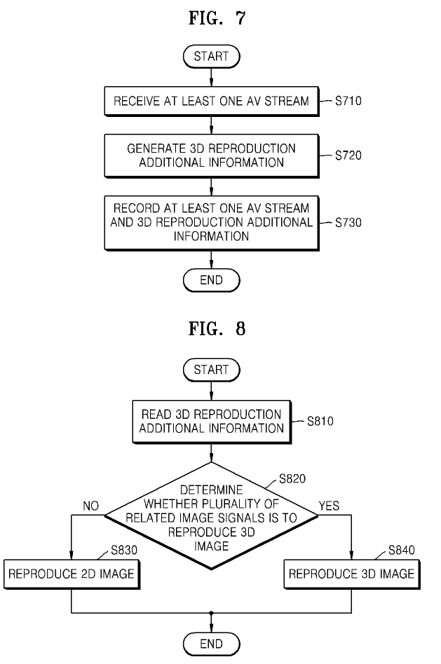

FIG. 6A is a block diagram of an apparatus for reproducing a recording medium according to another exemplary embodiment of the present invention.

When a disc is installed in an apparatus for reproducing, the reading unit 610 reads the AV stream recorded in the recording medium and the 3D reproduction additional information.

A buffer 620 buffers data read by the reading unit 610.

A first decoder 631 and a second decoder 632 respectively decode the plurality of related image signals.

A switch 640 performs a switching operation according to whether the plurality of related image signals are to reproduce a 3D image or to reproduce a 2D image. When the plurality of related image signals are to reproduce a 2D image as in PIP, the decoded image signals are blended and output. However, when the plurality of related image signals are to reproduce a 3D image, the image signals are not blended and are respectively output.

FIG. 6B is a block diagram of the apparatus for reproducing a recording medium of FIG. 6A according to another exemplary embodiment of the present invention.

The apparatus for reproducing a recording medium of FIG. 6B further includes a frame delaying unit 650, as compared with the apparatus of FIG. 6A. The frame delaying unit 650 delays the additional image signal for the reference image signal by a predetermined frame and output to a display device. When a 3D image is reproduced, the display device alternately displays received multi-view image signals. In this case, the display device should delay and display the image frames for the additional image signals. However, as in FIG. 6B, when the additional image signals are delayed in advance and output to the display device, the display device sequentially displays the received image signals.

FIG. 7 is a flowchart illustrating a method of recording data according to an exemplary embodiment of the present invention.

In operation S710, at least one AV stream providing the plurality of related image signals is received.

In operation S720, the 3D reproduction additional information to be used when reproducing a 3D image using the plurality of related image signals is generated. The 3D reproduction additional information may include at least one of the reproduction mode information, the multiplex format information, the image depth information, and the capturing information, wherein the reproduction mode information represents whether the corresponding image signal is a 3D image signal for reproducing a 3D image, the multiplex format information represents multiplexing of the image signal which corresponds to the 3D reproduction additional information, the image depth information represents whether the image signal corresponding to the 3D reproduction additional information includes information relating to depth, and the capturing information represents information about the image signal corresponding to the 3D reproduction additional information.

In addition, the 3D reproduction additional information may further include at least one of the relative position information, the focal length, and the angle value, wherein the relative position information represents the position of the camera capturing the image signal corresponding to the 3D reproduction additional information based on the position of the camera capturing the reference image signal, the focal length represents the focal length of a camera used in capturing the image signal corresponding to the 3D reproduction additional information, and the angle value represents information about the camera capturing the image signal corresponding to the 3D reproduction additional information being rotated based on a reference coordinate system. When the image signal corresponding to the 3D reproduction additional information includes the depth information, information about the maximum distance and the minimum distance between the camera capturing the image signal and the object to be captured may be further included in the 3D reproduction additional information.

In operation S730, the at least one AV stream and the 3D reproduction additional information are recorded to the optical recording medium.

FIG. 8 is a flowchart illustrating a method of reproducing data recorded to the recording medium according to an exemplary embodiment of the present invention.

In operation S810, the 3D reproduction additional information is read from the optical recording medium in which the reproduction additional information to be used when reproducing a 3D image using the at least one AV stream and the plurality of related image signals is recorded.

In operation S820, it is determined whether the plurality of related image signals are to reproduce a 3D image based on the 3D reproduction additional information.

According to the result of the determination in operation 820, a 3D image is selectively reproduced using the AV stream and the 3D reproduction additional information in operation S840 or a 2D image is reproduced in operation S830.

The method of reproducing data illustrated in FIG. 8 may further include reading the at least one AV stream at a speed two times faster than the standard speed, when it is determined that the plurality of related image signals are the 3D image signals. Here, a plurality of decoders are used to simultaneously decode the at least one AV stream.

According to the present invention, the 3D reproduction additional information is further recorded in the optical recording medium and a 3D image can be reproduced using the conventional optical recording medium, without changing the data structure of the optical recording medium.

The exemplary embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), and optical recording media (e.g., CD-ROMs, or DVDs).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of recording data, the method comprising:
receiving at least one audio/video (AV) stream which provides a plurality of related image signals;
generating three-dimensional (3D) reproduction additional information for reproducing a 3D image using the plurality of related image signals;
recording the at least one AV stream and the 3D reproduction additional information in a recording medium.

2. The method of claim 2, wherein the generating the 3D reproduction additional information comprises generating a plurality of pieces of 3D reproduction additional information which respectively correspond to the plurality of related image signals, each of the plurality of pieces of 3D reproduction additional information comprising at least one of reproduction mode information, multiplex format information, image depth information, and capturing information, the reproduction mode information representing whether the image signal corresponding to the 3D reproduction additional information is a 3D image signal for reproducing a 3D image, the multiplex format information representing multiplexing method of the image signal corresponding to the 3D reproduction additional information, the image depth information representing whether the image signal corresponding to the 3D reproduction additional information includes information relating to depth, and the capturing information representing parameter information used for capturing the image signal.

3. The method of claim 2, wherein the capturing information comprises at least one of relative position information, a focal length, and an angle value, the relative position information representing a relative position of a camera used in capturing the image signal corresponding to the 3D reproduction additional information based on a position of the camera used in capturing a reference image signal, the focal length representing the focal length of the camera used in capturing the image signal corresponding to the 3D reproduction additional information, and the angle value representing an angle between the camera used in capturing the image signal corresponding to the 3D reproduction additional information and a reference point.

4. The method of claim 2, wherein if the image signal corresponding to the 3D reproduction additional information comprises the image depth information, the 3D reproduction additional information further comprises at least one of a maximum distance and a minimum distance between a camera capturing the image signal and an object to be captured.

5. The method of claim 1, wherein the recording comprises representing the plurality of related image signals as image signals for providing multi-angle or as image signals for providing picture-in-picture.

6. The method of claim 2, wherein the recording medium is a Blu-ray disc and the 3D reproduction additional information is recorded to a play item field for the image signal corresponding to the 3D reproduction additional information.

7. The method of claim 1, wherein the recording medium is a digital versatile disc and the 3D reproduction additional information is recorded to a C_CAT field or a VTSI field for the image signal corresponding to the 3D reproduction additional information.

8. A method of reproducing data, the method comprising:
reading three-dimensional (3D) reproduction additional information from a recording medium in which at least one audio/video (AV) stream providing a plurality of related image signals and the 3D reproduction additional information for reproducing a 3D image using the plurality of related image signals are recorded;
determining whether the plurality of related image signals are 3D image signals for reproducing the 3D image, based on the 3D reproduction additional information; and
selectively reproducing the 3D image using the at least one AV stream and the 3D reproduction additional information based on a result of the determining.

9. The method of claim 8, wherein a plurality of pieces of 3D reproduction additional information respectively corresponding to the plurality of related image signals are recorded on the recording medium, each of the plurality of pieces of 3D reproduction additional information comprising at least one of reproduction mode information, multiplex format information, image depth information, and capturing information, the reproduction mode information representing whether the image signal corresponding to the 3D reproduction additional information is a 3D image signal for reproducing the 3D image, the multiplex format information representing multiplexing method of the image signal corresponding to the 3D reproduction additional information, the image depth information representing whether the image signal corresponding to the 3D reproduction additional information includes information relating to depth, and the capturing information representing parameter information used for capturing the image signal.

10. The method of claim 8, wherein the reproducing comprises reading the at least one AV stream at a speed two times faster than it generally reads the AV stream, if it is determined that the plurality of related image signals are the 3D image signals.

11. The method of claim 8, wherein the reproducing comprises simultaneously decoding the at least one AV stream using a plurality of decoders, if it is determined that the plurality of related image signals are the 3D image signals.

12. The method of claim 8, wherein the reproducing comprises:
decoding at least one AV stream; and
outputting information about a reference image signal from among the plurality of related image signals and the at least one decoded AV stream to a display device.

13. An apparatus for recording data, the apparatus comprising:
a receiver which receives at least one audio/video (AV) stream which provides a plurality of related image signals;
an information generator which generates three-dimensional (3D) reproduction additional information for reproducing a 3D image using the plurality of related image signals; and
a recorder which records the at least one AV stream and the 3D reproduction additional information in a recording medium.

14. The apparatus of claim 13, wherein the information generator generates a plurality of pieces of 3D reproduction additional information which respectively correspond to the plurality of related image signals, each of the plurality of pieces of 3D reproduction additional information comprising at least one of reproduction mode information, multiplex format information, image depth information, and capturing information, the reproduction mode information representing whether the image signal corresponding to the 3D reproduction additional information is a 3D image signal for reproducing the 3D image, the multiplex format information representing multiplexing method of the image signal corresponding to the 3D reproduction additional information, the image depth information representing whether the image signal corresponding to the 3D reproduction additional information includes information relating to depth, and the capturing information representing parameter information used for capturing the image signal.

15. The apparatus of claim 14, wherein the capturing information comprises at least one of relative position information, a focal length, and an angle value, the relative position information representing a relative position of a camera used in capturing the image signal corresponding to the 3D reproduction additional information based on a position of a camera used in capturing a reference image signal, the focal length representing the focal length of the camera used in capturing the image signal corresponding to the 3D reproduction additional information, and the angle value representing an angle between the camera used in capturing the image signal corresponding to the 3D reproduction additional information and a reference point.

16. The apparatus of claim 14, wherein when the image signal corresponding to the 3D reproduction additional information comprises depth information, the 3D reproduction additional information further comprises at least one of a maximum distance and a minimum distance between a camera used in capturing the image signal and an object to be captured.

17. The apparatus of claim 13, wherein the recorder represents the plurality of related image signals as image signals for providing multi-angle or as image signals for providing picture-in-picture.

18. The apparatus of claim 14, wherein the recording medium is a Blu-ray disc and the 3D reproduction additional information is recorded to play items for the image signal corresponding to the 3D reproduction additional information.

19. The apparatus of claim 14, wherein the recording medium is a digital versatile disc and the 3D reproduction additional information is recorded to a C_CAT field or a VTSI field for the image signal corresponding to the 3D reproduction additional information.

20. An apparatus for reproducing data, the apparatus comprising:
a reading unit which reads three dimensional (3D) reproduction additional information from a recording medium in which at least one audio/video (AV) stream providing a plurality of related image signals and the 3D reproduction additional information for reproducing a 3D image using the plurality of related image signals are recorded;
a determining unit which determines whether the plurality of related image signals are 3D image signals for reproducing the 3D image, based on the 3D reproduction additional information; and
a reproducing unit which selectively reproduces the 3D image using the at least one AV stream and the 3D reproduction additional information based on a result of the determination by the determining unit.

21. The apparatus of claim 20, wherein a plurality of pieces of 3D reproduction additional information respectively corresponding to the plurality of related image signals are recorded the recording medium, each of the pieces of 3D reproduction additional information comprising at least one of reproduction mode information, multiplex format information, image depth information, and capturing information, the reproduction mode information representing whether the image signal corresponding to the 3D reproduction additional information is a 3D image signal for reproducing the 3D image, the multiplex format information representing multiplexing method of the image signal corresponding to the 3D reproduction additional information, the image depth information representing whether the image signal corresponding to the 3D reproduction additional information includes information relating to depth, and the capturing information representing parameter information used for capturing the image signal.

22. The apparatus of claim 20, wherein the reading unit reads the at least one AV stream at a speed two times faster than it generally reads the AV stream, if it is determined that the plurality of related image signals are the 3D image signals.

23. The apparatus of claim 20, wherein the reading unit simultaneously decodes the at least one AV stream using a plurality of decoders, if it is determined that the plurality of related image signals are the 3D image signals.

24. The apparatus of claim 20, wherein the reproducing unit comprises:
a decoder which decodes the at least one AV stream; and
an outputting unit which outputs information about a reference image signal from among the plurality of related image signals and the at least one decoded AV stream to a display device.

25. An optical recording medium having recorded therein at least one audio/video (AV) stream which provides a plurality of image signals and three-dimensional (3D) reproduction additional information for reproducing a 3D image using the plurality of image signals.

26. The optical recording medium of claim 25, further having therein a plurality of pieces of 3D reproduction additional information respectively corresponding to the plurality of related image signals recorded thereto, each of the plurality of pieces of 3D reproduction additional information comprising at least one of reproduction mode information, multiplex format information, image depth information, and capturing information, the reproduction mode information representing whether the image signal corresponding to the 3D reproduction additional information is the 3D image signal for reproducing a 3D image, the multiplex format information representing multiplexing method of the image signal corresponding to the 3D reproduction additional information, the image depth information representing whether the image signal corresponding to the 3D reproduction additional information includes information relating to depth, and the capturing information representing parameter information used for capturing the image signal.

27. The optical recording medium of claim 26, the recording medium is a Blu-ray disc and the 3D reproduction additional information is recorded in a play item field for the image signal corresponding to the 3D reproduction additional information.

28. The optical recording medium of claim 26, the recording medium is a digital versatile disc and the 3D reproduction additional information is recorded to a C_CAT field or a VTSI field for the image signal corresponding to the 3D reproduction additional information.
